(19) United States
(12) Patent Application Publication
(10) Pub. No.: US 2007/0244798 A1
(43) Pub. Date: Oct. 18, 2007

(54) SYSTEMS AND METHODS FOR REAL ESTATE PROCESS MANAGEMENT

(76) Inventor: Jason Weidenbenner, Salt Lake City, UT (US)

Correspondence Address: BAKER & ASSOCIATES PLLC, 470 EAST NINTH AVENUE, SALT LAKE CITY, UT, 84103, US

(21) Appl. No.: 11/689,185

(22) Filed: Mar. 21, 2007

Related U.S. Application Data
(60) Provisional application No. 60/743,627, filed on Mar. 22, 2006.

(51) Int. Cl. G06Q 40/00

(52) U.S. Cl. 705/37

(57) ABSTRACT

The present invention relates to systems and methods that may be used to facilitate paperless real estate acquisition. One embodiment of the present invention relates to a paperless method of generating and submitting a legally binding real estate offer to purchase an electronically identified property. The method includes identifying a target property according to a correlation algorithm that utilizes a set of target characteristics specific to a buyer. An offer framework is prepared to purchase the target property including the target property location and offer price. The offer framework is electronically authenticated so as to form a legally binding offer to purchase the target property. The legally binding offer is transmitted to a correspondent for the property. A second embodiment of the present invention relates to an electronic offer generation system, including a property identification module, an offer generation module, and a communication module.

### RELATED APPLICATIONS

This application claims priority to U.S. provisional application Ser. No. 60/743,627 filed Mar. 22, 2006, the contents of which are incorporated by reference.

### FIELD OF THE INVENTION

The invention generally relates to systems and methods for real estate process management. In particular, the invention relates to systems and methods used to facilitate paperless real estate acquisition.

### BACKGROUND OF THE INVENTION

Real estate refers to physical land and permanent structures attached thereto. Real estate is commonly transferred among corporations and individuals throughout the world. To facilitate these transfers, many countries utilize licensed real estate agents to assist buyers and sellers with the process. A simplified version of the process generally involves a buyer making an offer, a seller accepting an offer, and the buyer and seller subsequently performing various duties including disclosurers, repairs, signatures, financing, etc. An offer to purchase real estate is generally a legally binding contract that includes the description of the property to be purchased, an offered purchase price, and various terms relating to the purchase.

The acceptance of a buyer's offer can depend on a multitude of variables including the price, offer appearance, reputation of the buyer, reputation of the buyer's appointed real estate agent, etc. Therefore, the generation and submission of an offer requires that a buyer and/or buyer's appointed real estate agent spend a requisite amount of time manually preparing the offer document so as to maximize its potential for acceptance. However, it is also desirable for investors and real estate agents to make profitable offers on as many properties as possible. Therefore, the conventional manual paper-based offer generation systems prevent investors and real estate agents from making as many professional and legal offers as they may otherwise wish.

Various electronic systems and products have been developed to increase the efficiency at which a real estate acquisition is performed. These systems include electronic templates, online collaboration, and information databases. Electronic templates provide an initial framework of repetitive legal language necessary to enable a buyer or agent to simply fill in the blanks corresponding to particular aspects of an identified property and an offer price. Likewise, online collaboration databases include information about properties for sale and tools for electronically facilitating transactions between sellers, buyers, and agents. Unfortunately, both of these existing systems and corresponding methods of use require one or more manual paper-based operations to effectuate a legally binding offer to purchase a target property. These paper-based operations include printing the offer and manually signing it so as to be legally binding. The manually signed offer must then be retransmitted to the user, agent, other party, and/or electronic database for subsequent processing. This manual operation significantly hinders the efficiency of the real estate acquisition process. In addition, the use of these partial-electronic real estate systems often results in the offer having an impersonal or automated appearance, which may result in a decrease in its likelihood of acceptance.

In addition, the ability to generate a legally binding offer to purchase an item of real estate cannot simply be created by eliminating the buyer's authentication. Some electronic real estate acquisition systems electronically create what is otherwise known as a “letter of intent” to purchase a property. A letter of intent is a non-binding statement stating that a buyer is interested in purchasing a particular piece of property. A seller that is faced with a choice between a letter of intent and a valid, legally binding offer is almost always likely to choose the valid offer in order to minimize risk.

The necessity of one or more paper-based operations not only impedes process efficiency but also creates significant potential for fraud. First, the transmission of documents to be paper-authenticated or documents already paper-authenticated may be intercepted, resulting in some form of crime. Second, paper-based authentications are very difficult to verify for accuracy, enabling fraudulent practices of individuals mimicking the signature of others. These fraudulent practices may cause legal problems for a buyer and result in the loss of a targeted property. Third, personal and/or sensitive information from paper-authenticated documents that are not securely destroyed may be acquired by malicious individuals.

Therefore, there is a need in the industry for systems and methods that facilitate an efficient paperless real estate acquisition.

### SUMMARY OF THE INVENTION

The present invention relates to systems and methods that may be used to facilitate paperless real estate acquisition. One embodiment of the present invention relates to a paperless method of generating and submitting a legally binding real estate offer to purchase an electronically identified property. The method includes identifying a target property according to a correlation algorithm that utilizes a set of target characteristics specific to a buyer. An offer framework is prepared to purchase the target property including the target property location and offer price. The offer framework is electronically authenticated so as to form a legally binding offer to purchase the target property. The legally binding offer is transmitted to a correspondent for the property. A second embodiment of the present invention relates to an electronic offer generation system, including a property identification module, an offer generation module, and a communication module. In addition, the legally binding offer to purchase the property may have the appearance of a manually prepared offer so as to increase the likelihood of acceptance.

Embodiments of the present invention represent a significant advance over the prior art by eliminating the need to utilize paper to authenticate a real estate purchase offer. Conventional real estate offers are manually prepared by a buyer or agent and manually signed/authenticated by the buyer so as to be legally binding. Prior art electronic real estate systems automate components of the real estate purchase process but fail to completely eliminate the need for a manual authentication. The elimination of printing and manually signing documents dramatically increases the efficiency of purchasing real estate. In addition, numerous security risks associated with paper and tangible medium documents are eliminated.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular-rather than complete-portions of the systems and methods of making and using the port system according to the invention. In the Figures, the physical dimensions may be exaggerated for clarity. The same reference numerals in different drawings represent the same element, and thus their descriptions will be omitted.

FIG. 1 illustrates a block diagram of a suitable computer operating environment for embodiments of the present invention;

FIG. 2 illustrates a flow chart of a method for generating and submitting a legally binding real estate offer to purchase an electronically identified property in accordance with one embodiment of the present invention;

FIG. 3 illustrates an operational flow chart of a detailed view of one embodiment of act 230 in FIG. 1;

FIG. 4 illustrates a flow chart of a detailed view of one embodiment of act 240 in FIG. 1;

FIG. 5 illustrates an operational block diagram of an electronic real estate offer generation and transmission system in accordance with a second embodiment of the present invention;

FIG. 6 illustrates a graphical user interface view of one embodiment of a system/module for configuring target characteristics and/or client data;

FIG. 7 illustrates a graphical user interface view of one embodiment of a system/module for recording data related to agents;

FIG. 8 illustrates a graphical user interface view of a security interface that may be incorporated into one or more of the embodiments of the present invention;

FIG. 9 illustrates an Internet domain interface which may be used to facilitate target characteristic configuration and/or digital authentication with one or more embodiments of the present invention;

FIG. 10 illustrates a graphical user interface view of a module/system to generate offers and manage information related to outstanding offers;

FIG. 11 illustrates a graphical user interface view of a module/system that manages target characteristics and conditional offer terms;

FIG. 12 illustrates a digital authentication interface which may be used to facilitate a paperless buyer authentication in accordance with embodiments of the present invention; and

FIG. 13 illustrates an alternative digital authentication interface which may be used to facilitate a paperless buyer authentication in accordance with embodiments of the present invention.

### DETAILED DESCRIPTION OF THE INVENTION

The present invention relates to systems and methods that may be used to facilitate paperless real estate acquisition. One embodiment of the present invention relates to a paperless method of generating and submitting a legally binding real estate offer to purchase an electronically identified property. The method includes identifying a target property according to a correlation algorithm that utilizes a set of target characteristics specific to a buyer. An offer framework is prepared to purchase the target property including the target property location and offer price. The offer framework is electronically authenticated so as to form a legally binding offer to purchase the target property. The legally binding offer is transmitted to a correspondent for the property. A second embodiment of the present invention relates to an electronic offer generation system, including a property identification module, an offer generation module, and a communication module. In addition, the legally binding offer to purchase the property may have the appearance of a manually prepared offer so as to increase the likelihood of acceptance. Also, while embodiments of the present invention are described in reference to systems and methods for electronic real estate acquisition, it will be appreciated that the teachings are applicable to other areas.

The following terms are defined as follows:

Property—a specific piece of real estate, including undeveloped land, developed land, etc.

Offer—an offer from a buyer to a seller to purchase a particular property for a particular price; an offer is generally formatted to include certain information about a buyer which may be used by the seller in evaluating whether to accept the offer. The information included in the offer may also optionally include conditional purchasing terms, financial qualifications, a letter of pre-loan qualification, etc. The term “offer” may be used interchangeable with the term “bid”.

Real estate agent—an individual appointed by a buyer or seller to act on their behalf with respect to aspects of real estate transactions.

Buyer—an individual or corporation who wishes to purchase a particular unit of real estate.

Seller—an individual or corporation that is responsible for transferring a unit of real estate.

Legally binding real estate offer—a legally enforceable offer which, if accepted, legally binds a buyer to purchase an identified piece of release estate under contract laws.

Buyer's property purchasing preferences—any characteristics, relational factors, and/or factors about real estate that affect a particular buyers decision about whether to purchase an item of real estate. For example, a relational factor may include the listing price being below an estimated value or a ratio between the listing price and the estimated value.

Target characteristics—a set of variables corresponding to a buyer's property purchasing preferences that can be mathematically compared to information available for properties for sale.

Correlation algorithm—a mathematical process that compares variables to identify items that fall within a particular set of criteria or matching criteria.

Offer framework—an otherwise legally binding offer to purchase real estate other than the buyer's authentication.

Offer document template—an offer to purchase real estate that includes blanks for filling in information specific to the property to be purchased and the buyer's authentication.

Purchase terms—additional terms, conditions, or obligations which may be inserted into an offer to purchase real estate.

Electronic buyer authentication—A buyer authentication that is performed with an electronic process.

Paperless—an operation, act, or step that is performed without the reduction to paper.

Tangible medium—any fixed expression of information, including paper.

Affirmative paperless act—an intentional action performed that does not include the use of paper. For example, digitally stamping an electronic document with a digital image representation of a user's handwritten signature is an affirmative paperless act.

The following disclosure of the present invention is grouped into two subheadings, namely “Operating Environment” and “Electronic Offer Generation Method and System”. The utilization of the subheadings is for convenience of the reader only and is not to be construed as limiting in any sense.

### Operating Environment

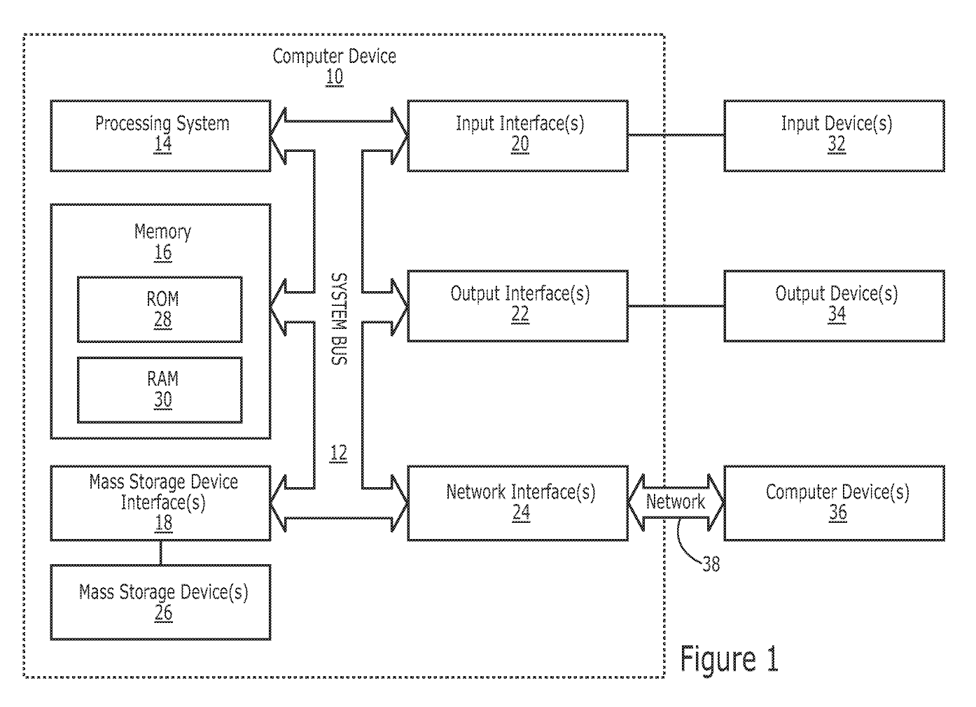

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”), smart phone, or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Electronic Offer Generation Method and System

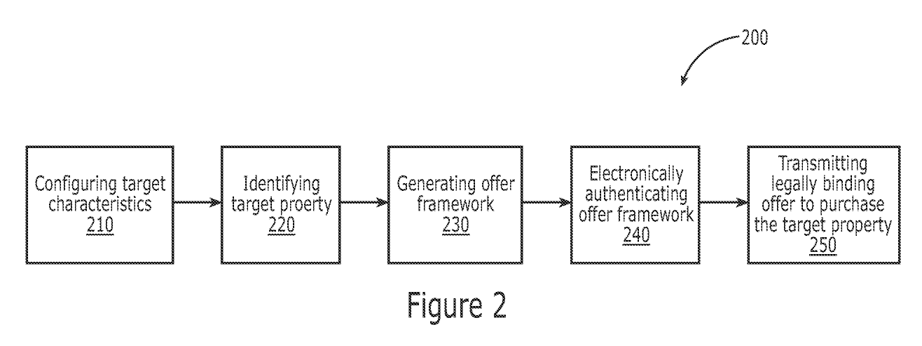

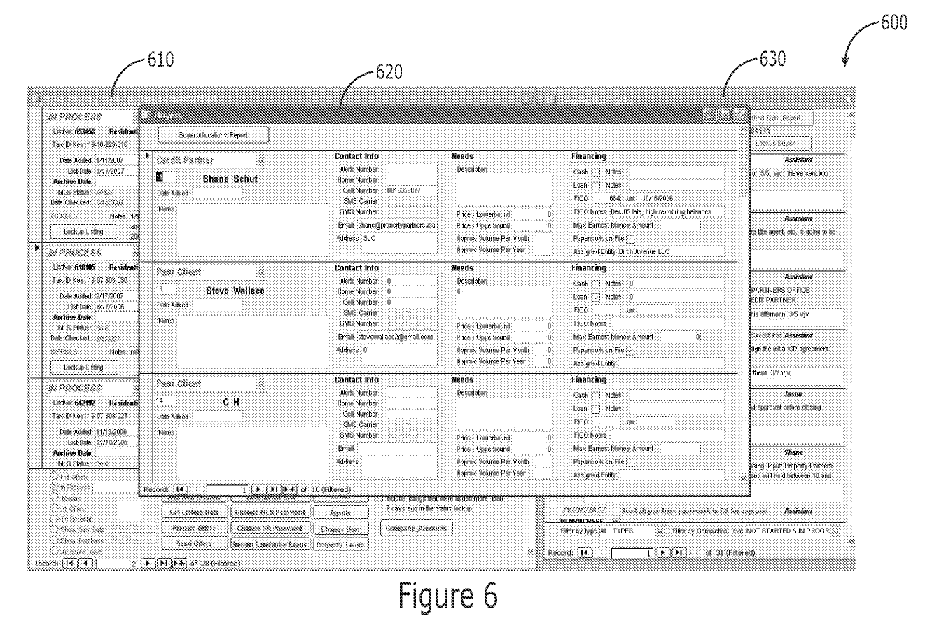

Reference is initially made to FIG. 2, which illustrates a flow chart of a method for generating and submitting a legally binding real estate offer to purchase an electronically identified property in accordance with one embodiment of the present invention, designated generally at 200. The method may be utilized in any type of real estate transaction including but not limited to residential, commercial, etc. The individual acts of the method may be performed in any order so as to generate a legally binding offer to purchase an electronically identified property. Initially, a set of target characteristic are configured, act 210. Target characteristics refer to buyer preferences that may be analyzed on one or more databases of properties for sale. Target characteristics may include variable ranges, specific variable requirements, mathematical relationships, etc. For example, a set of target characteristics may include a listing price range between $100,000 and $300,000. This range would then be used in selecting specific properties to make an offer on. Likewise, a specific variable target characteristic may be a requirement that any property have three bedrooms. A mathematical relationship may be a relationship between a calculated value and a listing price such as a listing price below the calculated value. Various methods may be used to configure the target characteristics, including input through a graphical user interface, indirectly communicated through a buyer, and/or some combination thereof. A real estate agent may collaborate with a buyer in the process of selecting target characteristics. Alternatively, some form of virtual or interactive computer support system may assist a buyer in the process of selecting target characteristics. One embodiment of a specific graphical user interface for the input of target characteristics is illustrated in FIG. 6.

A target property is identified, act 220. The act of identifying a target property includes utilizing a correlation algorithm of the target characteristics upon a database of properties for sale. The database of properties may include one or more electronic databases such as the multiple listing service (MLS), zillow.com, appraisal databases, tax assessment databases, recent housing sale databases, etc. The correlation algorithm is a mathematical process that may include systematically analyzing data about properties for sale on the database in relation to the target characteristics to identify matching criteria. For example, if one of the target characteristics is to identify properties with a listing price below an estimated value, the correlation algorithm may calculate the estimated value for a particular property by accessing appraisal and house sale data and then comparing the calculated value to the listing price. If a property meets the criteria of the target characteristics, it is identified. The act 220 of identifying the target poperty may be an automated electronic process. Alternatively, act 220 may be a manual or partial-manual process in which a user selects a property after viewing available properties on the database. The identified property includes specific data such as a correspondent and a location. The correspondent is often responsible for managing offers to purchase the property and may be the seller themselves or an appointed agent. Some form of communication medium is often specified such as an email, phone number, fax, etc through which the correspondent wishes to received offers to purchase the property. The location is the address or legal description of the property for sale which must be included in the offer.

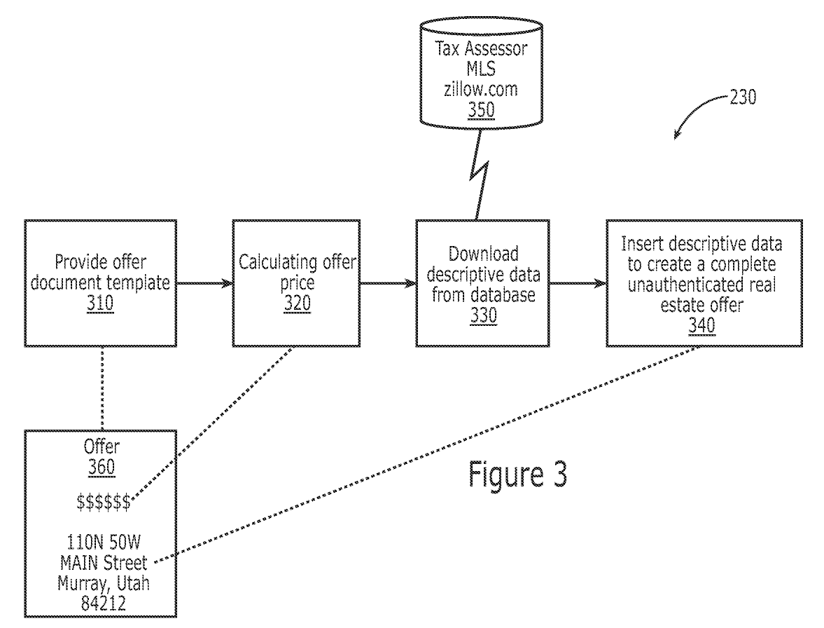

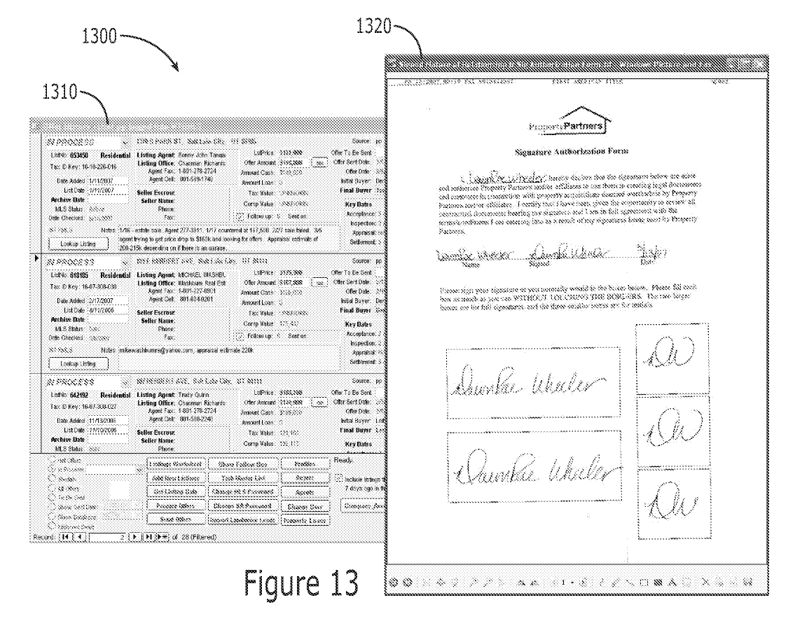

An offer framework to purchase the target property is generated, act 230. The offer framework is defined as an otherwise legally binding offer to purchase real estate other than the buyer's authentication. Therefore, the offer framework includes the necessary legal language to bind the buyer to purchase the target property. The laws governing offers and acceptances are generally state contract laws and therefore the exact language necessary to create an offer framework may be adjusted according to the location of the buyer, the location of the seller, case law, statutes, etc. The act may include accessing a local database which provides real estate offer forms such as an MLS site for real estate agents. The offer framework generally includes the target property location and an offer price. The target property location is a sufficiently specific description of the target property so as specify the target property. The offer price is a currency amount that the buyer is obligated to pay for the target property if the offer is accepted. The offer may include various other information such as the correspondent, an offer expiration, additional terms upon which the offer is contingent, etc. One detailed process of generating an offer framework is illustrated and described with reference to FIG. 3. Likewise, one example of a generated offer framework awaiting a buyer authentication is illustrated in FIG. 13. The act of generating the offer framework may include manual input, review and/or editing. For example, a buyer or agent may wish to adjust an automatically generated offer price to be included in the offer framework. In addition, the offer framework may include agent information and/or an agent authentication.

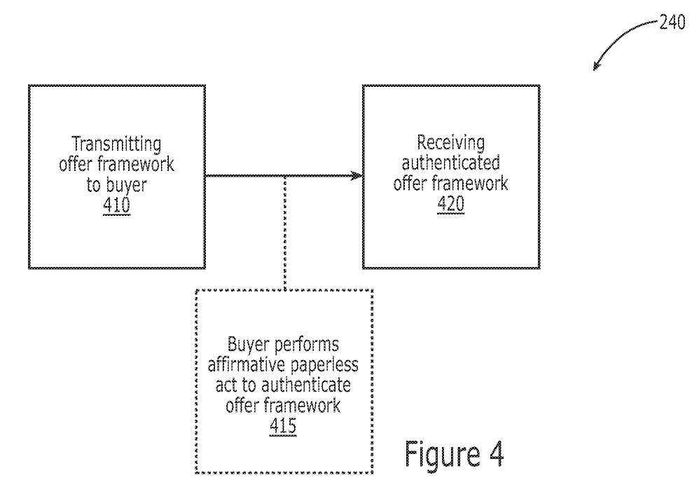

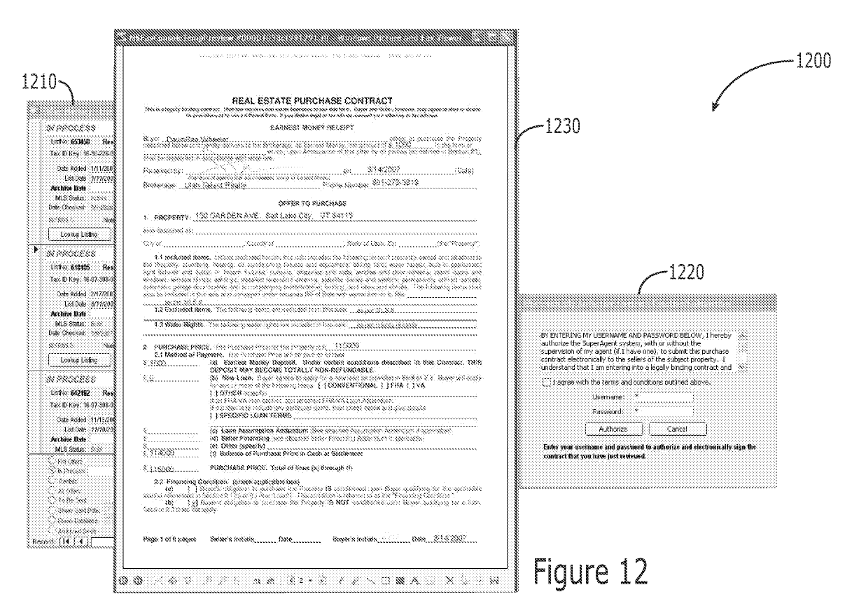

The offer framework is electronically authenticated so as to generate a legally binding offer to purchase the target property, act 240. In one embodiment, the electronic authentication is performed by the buyer and is a paperless authentication, including the performance of an affirmative paperless act by the buyer to legally authenticate the offer framework. The term “paperless” refers to a process that does not include the use of paper or writing mediums. Therefore, printing, signing, scanning, and then sending an electronic document is NOT paperless because it included printing the document onto a writing medium. An affirmative paperless act is an intentional action meant to effectuate the result of authenticating the offer framework. Various methods of facilitating this electronic authentication may be used, including but not limited to the process illustrated and described with reference to FIG. 4. In addition, the electronic authentication may be a one-time representative authentication such as a power of attorney that authorizes a representative to legally authenticate the offer framework on their behalf. One example of a one-time authentication is illustrated and described in reference to FIG. 13. The representative could then repetitively perform the remaining acts of the electronic process and make numerous legally binding offers. Alternatively, the electronic authentication may be performed subsequent to the generation of the offer framework. One example of a subsequent authentication is illustrated and described in reference to FIG. 12.

The electronic authentication (act 240) may include electronic authentications from one or more individuals/corporations including the buyer, real estate agent, financing representative, etc. Each of these parties may separately perform an affirmative paperless act to authenticate the offer framework. The appearance of the electronic authentication may also take various forms depending on the process and technology used to perform the authentication. For example, the electronic authentication may appear to be a handwritten signature which was electronically stamped onto the offer framework through a paperless process. The appearance of a handwritten signature could increase the professional appearance of the resulting offer if the seller or seller's agent is unfamiliar with electronic offers. Alternatively, the electronic authentication may appear as a certified stamp similar to that of a notary indicating that the buyer has authenticated the offer.

The authenticated offer framework is then transmitted to the correspondent for the target property thereby creating a legally binding offer to purchase the target property, act 250. The transmission may be in any form including but not limited to a fax, email, direct data transfer, etc. The act of transmitting may include analyzing the correspondent information provided on the property database and selecting the ideal transmission medium. The transmission may also include various transmission security measures such as data encryption. The creation of a legally binding offer to purchase the target property means that if the seller accepts the offer, the buyer is under a contractual obligation to purchase the target property for the offer price included in the offer. The seller or seller's representative may make also make a counter-offer and/or reject the offer. Various additional acts may be added to electronically facilitate a counter-offer negotiating system.

Reference is next made to FIG. 3, which illustrates an operational flow chart of a detailed view of one embodiment of act 230 in FIG. 1. The detailed embodiment of act 230 includes a specific process for creating an offer framework so as to be a legally binding offer to purchase the target property other than the buyer authentication. Therefore, the resulting offer framework is a complete unauthenticated real estate offer to purchase the target property. Initially, an offer document template is provided, act 310. The offer document template may be a locally stored template or a template accessed from a particular database depending on the location of the target property. The offer document template 360 is a legal offer document with specific blanks or entries for information specific to the target property. Real estate agent associations commonly provide a real estate purchase agreement contract (REPC) that includes numerous form fillable blanks specific to a particular transaction. The offer price is then calculated and inserted into the offer document template, act 320. The offer price may be manually reviewed, entered, adjusted, edited, and/or influenced by the buyer or agent. Various interfaces or electronic processes may be utilized to enable the manual interaction of the buyer or agent with respect to the offer price. Descriptive data about the target property is downloaded from one or more databases 350, act 330. The descriptive data includes a description of the target property and the correspondent. The description may be a legal description defining the metes and bounds of the property or a conventional street address sufficient to specify the target property. The correspondent may be the seller or any individual appointed to manage the transaction. The descriptive data is inserted into the template 360 to create a complete unauthenticated offer to purchase the target property, act 340. In addition, various optional acts may be included to facilitate the automatic or manual insertion of additional terms into the offer template such as conditions that must be satisfied before purchase. For example, an offer may be conditioned on a proper appraisal, environmental assessment, building inspection certification, etc.

Reference is next made to FIG. 4, which illustrates a flow chart of a detailed view of one embodiment of act 240 in FIG. 1. The illustrated process is a specific embodiment of an electronic authentication process from the perspective of an electronic offer generation system in accordance with act 240 illustrated in FIG. 1. The offer framework is transmitted to the buyer, act 410. The transmission of the offer framework may include enabling the buyer to remotely access a local version of the offer framework data transmitted over the Internet to the buyer's location. Alternatively, the transmission may include a conventional transmission of the offer framework via an electronic medium such as email or fax. The authenticated offer framework is received, act 420. Although the illustrated process gives the perspective of an electronic offer generation system, an act performed by the buyer is illustrated for contextual purposes to explain the specific electronic authentication embodiment. The buyer performs an affirmative paperless act to authenticate the offer framework. The affirmative paperless act is an intentional action by the buyer with the intent to effectuate the authentication of the offer framework. The affirmative paperless act does not include any steps that involve the printing or transmission of the offer framework to paper or some other form of writable medium. As discussed above, various actions may be used as affirmative paperless acts in accordance with embodiments of the present invention.

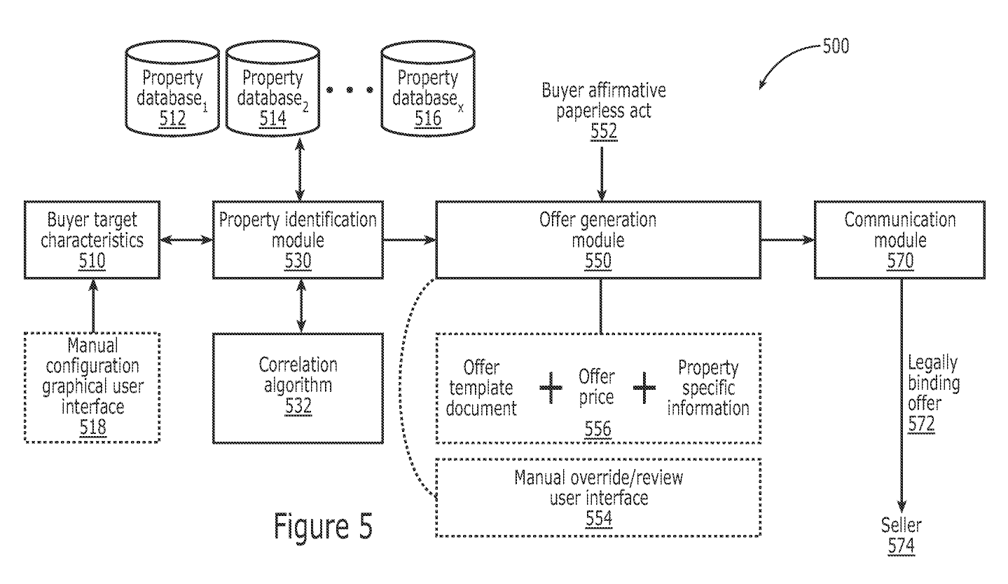

Reference is next made to FIG. 5, which illustrates an operational block diagram of an electronic real estate offer generation and transmission system in accordance with a second embodiment of the present invention, designated generally at 500. The system 500 may be used to electronically generate legally binding real estate offers. The system 500 includes a property identification module 530, an offer generation module 550, and a communication module 570. The property identification module 530 includes systems for identifying a set of buyer target characteristics 510 which may further include a manual configuration user interface 518. As described above, the target characteristics are a set of preference variables and relationships corresponding to the buyer's preferences for properties to be purchased. The property identification module 530 is also data coupled with one or more property databases 512, 514, 516 to obtain specific data about properties for sale, including identification, location, listing price, and correspondent information. The property identification module 530 also interfaces with a correlation algorithm 532 that matches criteria between the target characteristics and properties within the one or more databases 512, 514, 516. Depending on the target characteristics, the property identification module 530 will identify properties when certain criteria are matched. For example, if the target characteristics include a calculated value being below the listing price, the property identification module 530 will identify properties for sale in which this criterion is matched. Naturally, a multitude of criteria are often combined so as to limit the number of identified properties.

The offer generation module 550 includes a module for receiving a paperless affirmative action from the buyer 552, an offer framework module 556, and a manual user interface 554. The offer framework module 556 combines an offer template document, a calculated offer price, and property specific information to generate an offer framework. As described above, the offer template document may be an editable local form or a dynamically accessed document depending on the location of the identified property. The offer framework generated by the offer framework module 556 is authenticated by the buyer via the module for receiving the paperless affirmative action 552 to effectuate a paperless buyer authentication. The module for receiving the paperless affirmative action 552 may further include a graphical user interface such as the embodiments illustrated in FIGS. 12 and 13. The manual user interface 554 may enable the manipulation of the offer template and/or the addition of optional terms to the offer template such as conditions to be satisfied before purchase. The resulting authenticated offer may have the appearance of a manually prepared and manually authenticated offer to purchase the identified property. For example, the offer price, property location, and buyer authentication may be represented by images that appear to be handwritten.

The communication module 570 receives the authenticated offer framework from the offer generation module 550 and includes a data coupling to a transmission medium so as to electronically transmit the legally binding offer to a correspondent for the identified property. The transmission medium may include fax and email. The communication module may include security modules configured to encrypt or otherwise restrict the availability of the transmitted data to be intercepted and utilized.

Reference is next made to FIGS. 6-13 which illustrate specific user interface embodiments for use in conjunction with the methods and systems described above. FIG. 6 illustrates a graphical user interface view of one embodiment of a system/module for configuring target characteristics and/or client data, designated generally at 600. The illustrated interface is a set of Microsoft Access database screens with specific entries relating to characteristics of a buyer. The illustrated interface is designed to be used by an agent who interfaces with multiple buyers and therefore must organize each buyer's preferences as they relate to creating a set of target characteristics. The GUI 600 includes an offer history dialog 610, transaction tasks dialog 630, and a buyer data dialog 620. The offer history dialog 610, transaction task dialog 630, and buyer data dialog 620 include data interrelated to one another to facilitate various searching and correlation functionality. The buyer data dialog 620 includes the buyer's location, an upper and lower price limit, and the approximate volume of transactions per month and year. This data may be used to generate target characteristics for use with the systems and methods described above.

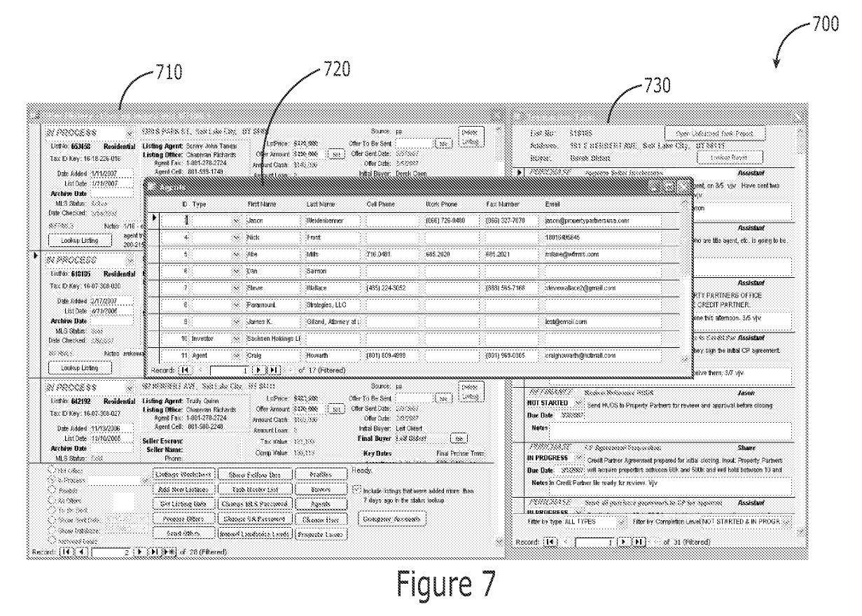

FIG. 7 illustrates a graphical user interface view of one embodiment of a system/module for recording data related to agents, designated generally at 700. The GUI 700 includes an offer history dialog 710, an agent data dialog 720, and a transaction task dialog 730. As described above, the dialogs include database information which may be used in conjunction to enable specific functionality. The agent data dialog may be used as correspondent information for the transmission of authenticated offers in accordance with the systems and methods described above.

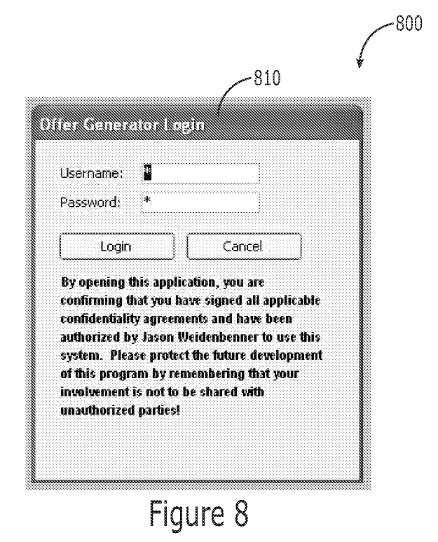

FIG. 8 illustrates a graphical user interface view of a security interface that may be incorporated into one or more of the embodiments of the present invention, designated generally at 800. The GUI 800 includes a security dialog 810 that requires a user to identify themselves to gain access to the system. This form of authentication may be used to authenticate offers and/or enable manual editing.

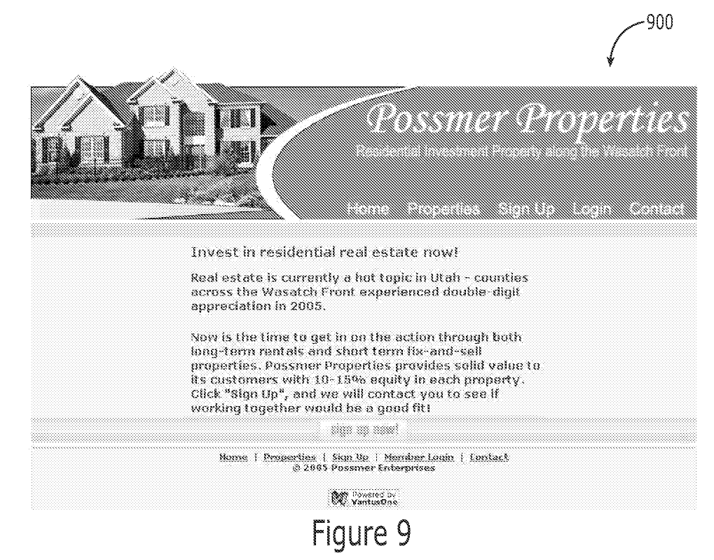

FIG. 9 illustrates an Internet domain interface which may be used to facilitate efficient target characteristic configuration and/or digital authentication with one or more embodiments of the present invention, designated generally at 900. An Internet domain interface is an example of an efficient electronic communication medium through which data may be transferred in various steps and modules of the present invention. For example, a buyer may be instructed to perform an affirmative paperless act to electronically authenticate an offer by connecting to an Internet domain interface. The buyer may be notified to perform this action via SMS, email, voice call, etc. Likewise, the illustrated Internet domain interface could be utilized to configure target characteristics for a buyer.

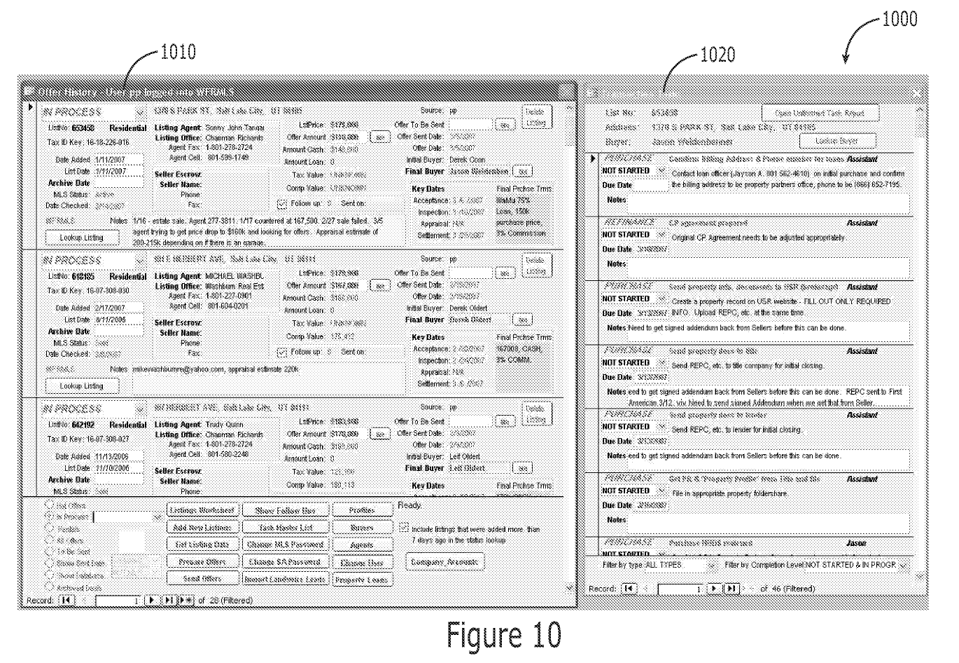

FIG. 10 illustrates a graphical user interface view of a module/system to generate offers and manage information related to outstanding offers, designated generally at 1000. The GUI 1000 includes an offer history dialog 1010 and a transaction task dialog 1020. The offer history dialog 1010 and transaction history dialog 1020 include data related to outstanding offers and specific task associated therewith. This type of electronic data storage may be used after an electronic offer is transmitted. The ability to electronically store and access offer history data enables a system to track subsequent events such as an inspection, a closing, title search, etc. In addition, individual offer history information may be utilized in conjunction with other offer history data to identify successful target characteristics or offer format strategies. Finally, the electronic storage of offer history data eliminates the need to store a paper copy or a digital image of the paper copy.

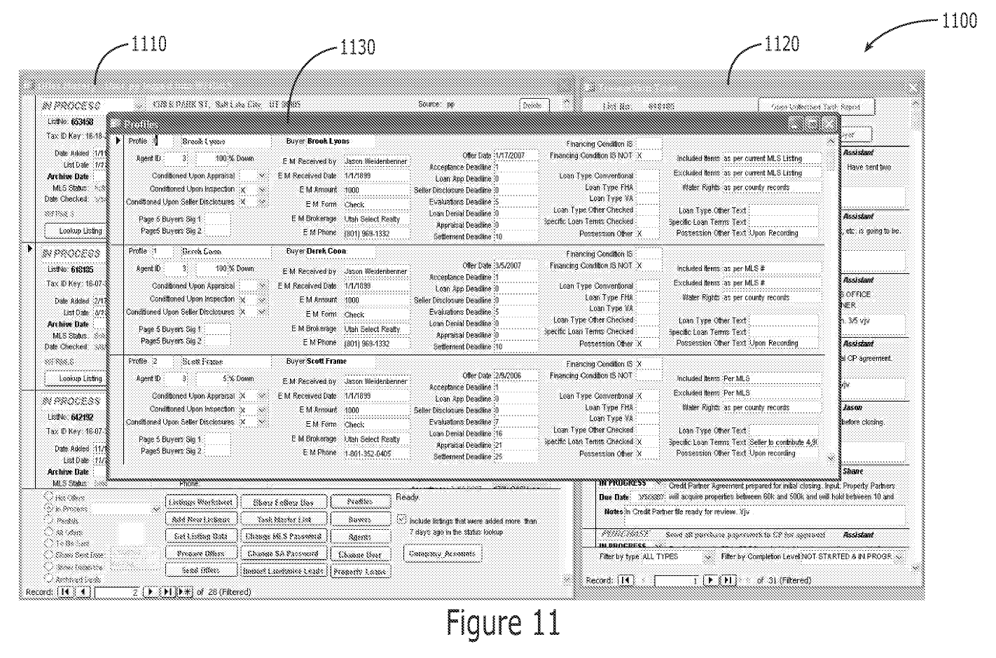

FIG. 11 illustrates a graphical user interface view of a module/system that manages target characteristics and conditional offer terms, designated generally at 1100. The GUI 1100 includes an offer history dialog 1110, a transaction task dialog 1120, and a profile data dialog 1130. The profile data dialog 1130 illustrates a set of target characteristics for particular buyers to be utilized in systems and methods for electronic offer generation. The target characteristics in the profile data dialog 1130 may be manually entered by the agent and/or buyer or automatically entered after a buyer is instructed to answer a series of interactive questions.

FIG. 12 illustrates a digital authentication interface which may be used to facilitate a paperless buyer authentication in accordance with embodiments of the present invention, designated generally at 1200. The GUI 1200 includes an offer history dialog 1210, a offer template 1230, and a buyer authentication input dialog 1220. This embodiment illustrates one method by which a buyer may electronically authenticate an offer template through the performance of an affirmative paperless act so as to create a legally binding offer to purchase a target/identified property. The buyer authentication input dialog 1220 requires the buyer/user to authorize the transaction. It will also be appreciated that the electronic authorization may appear on the document as a handwritten authentication, as illustrated in the bottom of the real estate offer framework 1230 with the buyer's initials.

FIG. 13 illustrates an alternative digital authentication interface which may be used to facilitate a paperless buyer authentication in accordance with embodiments of the present invention, designated generally at 1300. The GUI includes an offer history dialog 1310 and a pre-authorized document 1320 to enable a representative to authenticate on behalf of the buyer. The pre-authorized document 1320 may act as a legal power of attorney which enables the system to electronically authenticate documents on behalf of the buyer. The pre-authorization may take place before the identification and offer generation for particular properties.

What is claimed is:

1. An electronic method for generating and submitting a legally binding real estate offer to purchase an electronically identified property comprising the acts of:
providing a database of properties for sale;
configuring a set of target characteristics corresponding to a buyer's property purchasing preferences;
identifying a target property through application of a correlation algorithm of the target characteristics upon the database, wherein the identified target property includes a correspondent;
electronically generating an offer framework to purchase the target property including the target property location and offer price;
electronically authenticating the offer framework so as to generate a legally binding offer to purchase the target property; and
transmitting the legally binding offer to purchase the target property to the correspondent.

2. The method of claim 1, wherein the act of configuring a set of target characteristics corresponding to a buyer's property purchasing preferences includes an interactive communication between a buyer and an agent.

3. The method of claim 1, wherein the act of configuring a set of target characteristics corresponding to a buyer's property purchasing preferences includes defining a geographical region and a price range.

4. The method of claim 1, wherein the act of identifying a target property through application of a correlation algorithm of the target characteristics upon the database includes identifying matching criteria between the target characteristics and the identified target property.

5. The method of claim 1, wherein the act of identifying a target property through application of a correlation algorithm of the target characteristics upon the database includes manually selecting a property from the database.

6. The method of claim 1, wherein the act of identifying a target property through application of a correlation algorithm of the target characteristics upon the database includes manually reconfiguring the correlation algorithm to selectively weight individual target characteristics and relationships thereof.

7. The method of claim 1, wherein the act of electronically generating an offer framework to purchase the target property includes:
providing an offer document template;
calculating and inserting the offer price into the appropriate location on the offer document template;
downloading descriptive data from the database about the target property;
inserting the descriptive data into the appropriate locations on the offer document template to create an offer framework that is a complete unauthenticated real estate offer to purchase the target property;

8. The method of claim 1 further including the act of manually adjusting the offer price on the offer framework before transmitting the offer to the correspondent.

9. The method of claim 1 further including the act of adding purchase terms to the offer framework before transmitting the offer to the correspondent.

10. The method of claim 1, wherein the act of electronically authenticating the offer framework so as to generate a legally binding offer to purchase the target property includes:
electronically transmitting the offer framework to the buyer;
electronically receiving a legally binding offer to purchase the target property including an electronic buyer authentication, wherein the electronic buyer authentication is generated by the buyer by a process that includes the buyer receiving the offer framework and performing an affirmative paperless act to authenticate the offer framework;

11. The method of claim 9, wherein the electronic buyer authentication is an image of the buyer's signature and wherein the legally binding offer to purchase the target property has the appearance of a manually prepared and authenticated offer to purchase the target property.

12. The method of claim 1, wherein the act of electronically authenticating the offer framework so as to generate a legally binding offer to purchase the target property includes electronically receiving authority to act on behalf of the buyer and generating a legally binding electronic buyer authentication.

13. The method of claim 1, wherein the electronic buyer authentication is an image of the buyer's signature and wherein the legally binding offer to purchase the target property has the appearance of a manually prepared and authenticated offer to purchase the target property.

14. The method of claim 1, wherein the act of transmitting the legally binding offer to purchase the target property to the correspondent includes electronically transmitting the legally binding offer to purchase the target property to the correspondent.

15. The method of claim 1, wherein the acts are performed without reducing the target characteristics, offer framework, and legally binding offer to purchase the target property into a tangible medium.

16. An electronic real estate offer generation and transmission system comprising:
a property identification module, wherein the property identification module is data coupled to a database of properties for sale, and wherein the property identification module includes a correlation algorithm that mathematically correlates characteristics of the properties within the database with a set of target characteristics;
an offer generation module configured to prepare a legally binding offer to purchase a property identified by the property identification module including an automatically calculated offer price and an electronic authentication, wherein the electronic authentication includes a paperless buyer authentication; and
a communication module configured to electronically transmit the legally binding offer to a correspondent for the identified property.

17. The system of claim 15, wherein the offer generation module includes a graphical user interface that enables a user to manipulate the automatically calculated offer price.

18. The system of claim 15, wherein the paperless buyer authentication is an image of a buyer's signature and the legally binding offer has the appearance of a manually prepared and authenticated offer.

19. The system of claim 15, wherein the offer generation module includes a buyer authentication interface configured to display the offer to purchase the property and enable the buyer to make an affirmative paperless act to legally represent an authentication of the offer to purchase the property.

20. A method for submitting a legally binding real estate offer to purchase a property comprising the acts of:
providing a database of properties for sale;
configuring a set of target characteristics corresponding to a buyer's property purchasing preferences;
identifying a target property through application of a correlation algorithm of the target characteristics upon the database, wherein the identified target property includes a correspondent;
electronically generating an offer framework to purchase the target property including the target property location and offer price;
electronically authenticating the offer framework so as to generate a legally binding offer to purchase the target property, wherein the offer has the appearance of a manually prepared and authenticated offer; and
transmitting the legally binding offer to purchase the target property to the correspondent.
